(19) United States
(12) Patent Application Publication
(10) Pub. No.: US 2005/0243658 A1
(43) Pub. Date: Nov. 3, 2005

(54) Bible verse wristwatch

(76) Inventor: Joseph Mack, Rochester, NY (US)

Correspondence Address: Joseph Mack, 27 Arbutus Street, Rochester, NY, 14609, US

(21) Appl. No.: 10/835,090

(22) Filed: Apr. 30, 2004

(51) Int. Cl. A63F 3/00; G04C 17/00; G04B 19/00

(52) U.S. Cl. 368/223

(57) ABSTRACT

The present invention is a system that allows a user to selectively display time or display desired bible verses on an alphanumeric display of a wristwatch. The user or wearer designates the portion of the bible, the book, the chapter and the particular verse using number and scroll keys of a keyboard of the watch. The user can scroll through the verse as well as to previous and subsequent verses, chapters, and books using scroll keys.

### BACKGROUND OF THE INVENTION

1. Field of the Invention

The present invention is directed to a wristwatch that allows the user to access and display stored text contents and, more particularly, to a wristwatch that allows a user to display bible verses.

2. Description of the Related Art

Typical electronic wristwatches allow the user to display the time in various modes. Some wristwatches have small keyboards that allow the user to perform calculator operations, such as adding two numbers.

### SUMMARY OF THE INVENTION

It is an aspect of the present invention to provide a wristwatch that will allow a user or wearer to display bible verses as well as time

It is another aspect of the present invention is to allow the user to pick a desired bible verse and scroll through the testaments, books, chapters and verses of the bible.

The above aspects can be attained by a system that allows a user to selectively display time or display desired bible verses on an electronic display of a wristwatch. The user or wearer designates the portion of the bible, the book, the chapter and the particular verse using keys of a keyboard. The user can scroll through the verse as well as to previous and subsequent verses, chapters, and books using the keys.

These together with other aspects and advantages which will be subsequently apparent, reside in the details of construction and operation as more fully hereinafter described and claimed, reference being had to the accompanying drawings forming a part hereof, wherein like numerals refer to like parts throughout.

### BRIEF DESCRIPTION OF THE DRAWINGS

FIG. 1 depicts the exterior components of the wristwatch of the present invention.

FIGS. 2 and 3 show back and side views of the watch.

FIG. 4 depicts the electronic components of the watch.

FIG. 5 shows the operations of the watch.

### DETAILED DESCRIPTION OF THE PREFERRED EMBODIMENTS

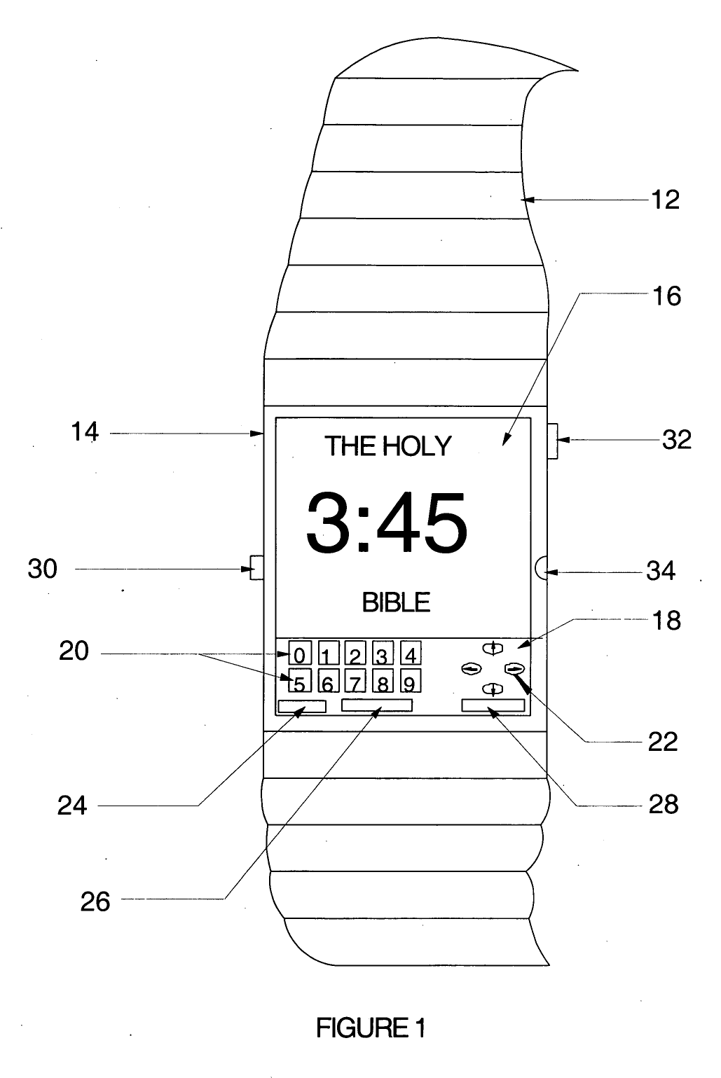

The present invention is directed to a wristwatch 10 that allows the user to access and display bible verses on a display of the wristwatch 10. A preferred embodiment of the watch is depicted in FIG. 1. The watch 10 includes a band 12 and an electronic watch 14. The watch 14 includes a conventional display 16, such as a liquid crystal display, capable of displaying alphanumeric text. The display 16 conventionally displays the time of day with date. The display 16 also displays bible verses as selected by the user or wearer as well as the bible verses selection information as it is entered into the watch 10. A conventional type keyboard 18 preferably includes ten number keys zero-nine 20 via which the user enters information, such as bible book, chapter and verse number to select a particular bible verse for display. Motion directional control keys 22 allow the user to scroll up, down, right and left within the bible text. A back key 24 allows a user to backup while entering information (or to back-up within the text), a space key 26 allows a user to put spaces between the entered information and an enter key 28 allows the user to enter the information to select a particular book, chapter and verse. A bible button 30 allows the user to enter a verse selection mode of the watch while a time and date button 32 allows the user to enter a time selection mode. A set button 34 allows the user to set the time and date, alarm and other watch functions in a conventional way.

During a typical sequence of operations the user may set the time using the keyboard 18 and the set button 34 and the watch will display the time in the time display mode. At some point the user may want to display a bible verse. To do so, preferably, the user depresses the bible button 34. At this point the watch 10 can display instructions or other text that indicates to the user that a verse can be selected. The keyboard 18 is used to enter the information for selecting a desired verse.

A number of different verse selection approaches can be used. In one approach the user enters the bible book number with the number keys 20, enters a space with the space key 24, enters a chapter number with the number keys 20, enters a space with the space key 24 and enters the verse number with the number keys 20. As the user enters the verse selection information, the information is displayed on the display 16. If the user needs to correct an error the back key 24 is used to back-up within the displayed selection information. The display might look like “1 3 12” after the user is finished entering the verse selection information signifying the selection of book 1 (Genesis), chapter 3 and verse 12. Once the user has the desired verse identification information displayed on the display 16, the user activates the enter key 28 and the watch displays the desired bible verse.

Another approach is for the watch to request entry of specific information. For example, the watch displays the instruction “Select The Bible Book”, and the user enters the book number with the keys 20 followed by activating the enter key 28. The watch displays the instruction “Select The Book Chapter”, and the user enters the chapter number with the keys 20 followed by depressing the enter key 28. The verse number is next entered after the displayed instruction “Select The Book Verse”. Other approaches can also be used. For example, number keys 20 need not be used and verse selection can be done with the scroll keys 22. For example, an up or forward key can be used to increment a book number displayed on the display 16 after an instruction such as “Use The UP Key To Count Up To A Book Number” until the user has reached the bible book number desired where upon the user hits the enter key 28. Similar incrementing can be used to select chapter and verse. Still other approaches are possible. The selection of the desired verse can be an even more instruction-based selection than discussed above. In this approach, once the user has selected the verse mode using button 30, the system displays a selection instruction such as “Press The UP Button For New Testament or Press the DOWN Button For Old Testament”. Once the selection is made, a list of bible books is presented. The user is instructed to scroll down through the books until the desired book is highlighted and activate the enter button 28 when the desired book is highlighted. After the desired bible book is selected, the user is instructed to enter the book number followed by “enter” and likewise the verse number, in the manner as described above. The scroll based selection of used for the selection of the books of the bible can also be used for selecting the testament as well as chapter and verse. For example, after the book is selected, a list of chapters can be provided and the user scroll through the chapters using keys 22 to the desired chapter whereupon the enter key is activated. Likewise, a verse list for the selected chapter can be displayed through which the user can scroll to select a verse. This would allow the input for verse selection to be three keys or buttons: up, down and enter.

In another and preferred approach, when the bible mode selection button 30 is activated, the system displays a list of all of the sixty books of the bible with the display centered on the 33^{rd} within this book, Micah, is highlighted. The user uses the scroll keys 22 to scroll to the desired book. When the enter key is activated, the first verse of the book is displayed and the user can scroll through the verses. If the user wants to see a particular verse, when the book is highlighted the user can use the number keys 20 to enter the chapter and verse separated by a space, followed by activating the enter key 28, as discussed above. If the first verse of the book is being displayed the user can back up to the book list display using the back key 24 and then enter chapter and verse. Changes to the entered chapter and verse can be made via the keys 22.

Once the enter key has been activated, after all the needed information has been entered, the watch 10 displays the selected verse on the display 16. Since the display is small, if the verse is long, the display 16 may only show a part of the desired verse. The motion control or scroll keys 22 are used to move forward or backward within a displayed verse, book or chapter. For example, the right and left keys may be used to move back and forth within the displayed verse while the up and down keys may move between verses, chapters, etc.

When the user has finished viewing the desired verse(s) the user can return the display to displaying the time by activating the time button 32. Or the watch can include a time-out function that returns the watch 10 to the time display mode after a period of keyboard use inactivity, such as 5 minutes.

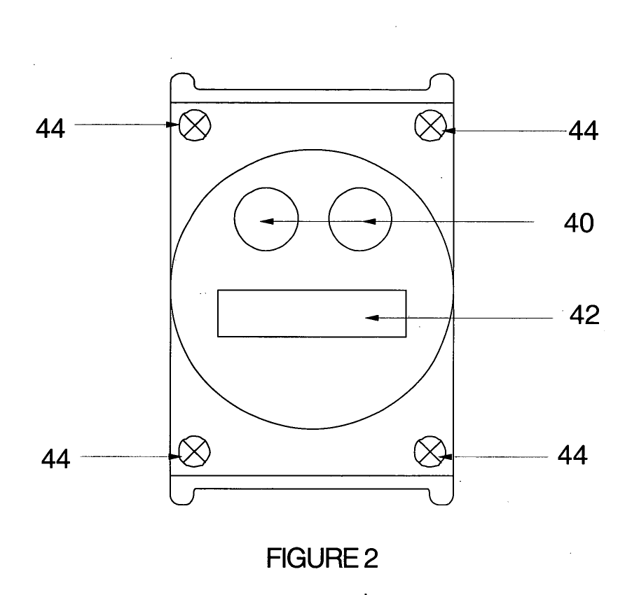

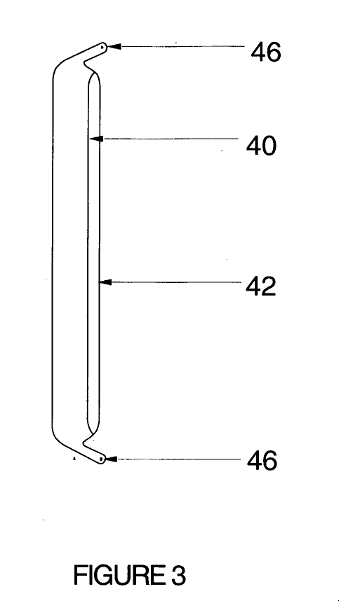

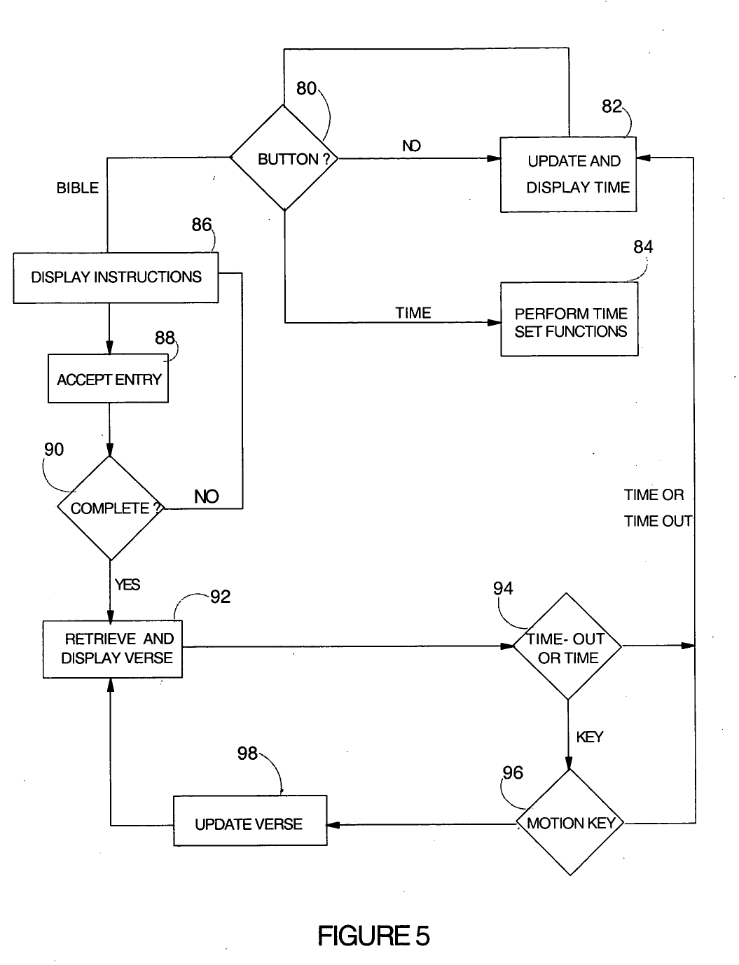

FIGS. 2 and 3 show back and side views, respectively, of the watch 14 with indications showing the inclusion of batteries 40, a processor 42, holding screws 44 and watchband pins. These views depict the watch as being a normal size type watch.

The present invention preferably has hardware components including the keyboard 18 having the keys 20, 22, 26 and 28. The keyboard 18 is connected to the processor 42. The processor also receives signals from buttons 30 and 32. The processor 42 provides output in the form of a time or verse alphanumeric display to the display 16, preferably a low power consumption liquid crystal type display. The processor 42 is also coupled to a memory 60. The components can also include a clock unit 62 providing a conventional clock source such as a quartz oscillator with oscillation counter. This clock unit 62 can be optional if the clock of the processor is accurate enough to be used as the time source. The processor 42 and memory 60 can be configured in a number of different ways. In a first approach the memory 42 can store the processor instructions for controlling the watch, such as for updating the displayed time, and the instruction allowing the user to select bible and enter verses as well as storing the bible verse text and state information, such as bible book, chapter and verse numbers entered. In another approach the processor 42 includes memory, ROM and RAM, for storing the control instructions and state information while the memory 60 stores the verse text. This configuration would allow the memory 62, for example, containing an English language version of the bible, to be swapped for a memory version containing the bible verses in the Spanish language. Other religious texts, as desired by the user, could also be available to the user through the watch 10 in this way. In another approach the memory 62 is not needed and the processor 42 includes the storage capacity needed to store the instructions the state information and the verse text.

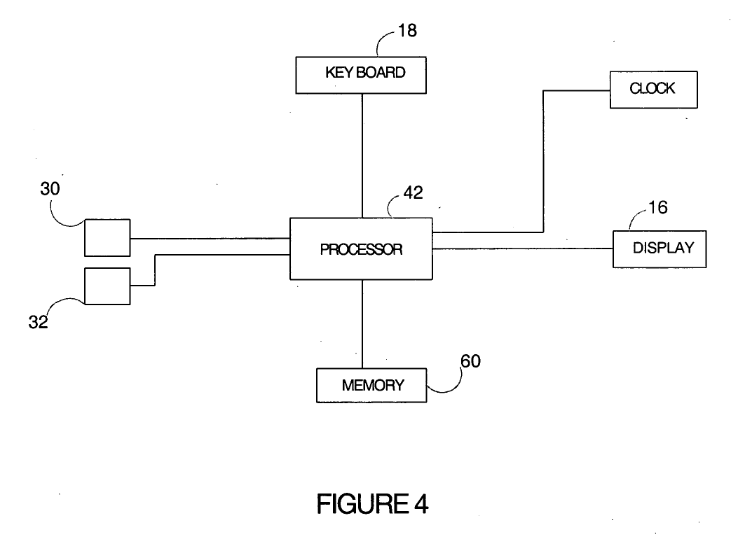

The operations of the processor 42 are depicted in FIG. 5. The system looks for the activation 80 of the time set 32 or bible verse 30 buttons. If no button activation is detected, the system updates 82 the current time in the state information and displays the current time. If the time set button is activated, the system performs 84 conventional time set functions with the user. If the bible button 30 is activated, the system enters a loop in which the system displays 86 the verse selection instructions, such as in the list of books selection choice approach discussed above. The system then awaits for and accepts 88 a selection entry, such as the activation of the enter key 28. The system then determines 90 whether verse entry selection information is complete. If not, such as when the entry is a scroll signal or a number from the keyboard, the system returns to display the next selection entry instruction, such as displaying a scrolled list of the books or the number entered and a chapter verse entry instruction. In this second selection cycle(s), the displayed information is changed as needed, such as additional scrolling or number/space entry, until the user activates the enter key 28, at which point the verse is displayed. During this loop, the user is allowed to change selection information.

Once the selection information is complete (90), the system retrieves and displays 92 the selected verse. The system then looks 94 for time button activation, a scroll key activation or a time-out. If a time-out occurs or the time set button has been activated, the system returns to update and display the tine. If a motion key has been selected, the system updates 98 the verse selection and display information. For example, if the down button is activated the verse selection information is updated to the next verse and it is retrieved and displayed 92. If the right button is activated the point within the verse that is at the beginning of the display is shifted right within the verse.

The verse text stored within the memory can be organized in a number of different ways. The different verses can be entries in an array such that book number and verse number access each entry. As another approach the books and verses can be arranged in a pointer directed list. The organization can include lists of testaments, book numbers with book names, chapter numbers and verses numbers to facilitate verse selection and scrolling. The memory can also allow the user to bookmark favorite verses.

The present invention has been described with respect to a watch that displays bible verses. Other functions can be provided. For example, the system can allow portions of verses to be highlighted. The watch can include a calculator function. A text keyboard could also be provided. The watch could output the selected verse as a voice signal speaking the verse with the addition of conventional text to voice conversion capability and a miniature sound transducer. The watch can also display pre-selected or randomly selected bible verses at selected times, such as hourly, triggered by a time signal similar to a conventional hourly or other time based alarm signal. A chime or other tone can also be produced when the verses is displayed. The watch can allow a user to bookmark favorite verses and call them up using the keyboard.

The many features and advantages of the invention are apparent from the detailed specification and, thus, it is intended by the appended claims to cover all such features and advantages of the invention that fall within the true spirit and scope of the invention. Further, since numerous modifications and changes will readily occur to those skilled in the art, it is not desired to limit the invention to the exact construction and operation illustrated and described, and accordingly all suitable modifications and equivalents may be resorted to, falling within the scope of the invention.

1. A wristwatch, comprising:
a bible verse selection unit operable by a wearer;
a processor receiving a bible verse selection input from the unit; and
a display displaying bible verses selected by the selection input.

2. A wristwatch as recited in claim 1, wherein the selection unit comprises a keyboard.

3. A wristwatch as recited in claim 1, wherein the selection unit comprises scroll and enter keys.

4. A wristwatch as recited in claim 1, wherein the selection unit allows the user to scroll through the verses.

5. A wristwatch as recited in claim 1, wherein the processor displays selection instructions on the display.

6. A wristwatch as recited in claim 5, wherein the processor displays selection instructions on the display including a list of bible books with a book that will be displayed if activated highlighted

7. A wristwatch as recited in claim 6, wherein the processor allows entry of a chapter and verse when the user desires a particular verse.

8. A wristwatch as recited in claim 1, further comprising a replaceable memory storing bible verse text and allowing substitution of language of the bible verses.

9. A wristwatch, comprising:
a bible verse selection keyboard operable by a wearer including number and scroll keys;
a processor containing a memory storing a list of bible verses and bible verse selection instructions, receiving a bible verse selection input from the keyboard, producing a verse selection display including the selection instructions and the selection input as received, accessing the list of bible verses responsive to the input to obtain a selected bible verse and producing a display output of the selected verse; and
a display displaying the verse selection display and the bible verse selected by the selection input and scrolled to by the scroll keys.

10. A process, comprising:
allowing a user to input a bible verse selection into a wristwatch; and
displaying a selected bible verse on a display of the wristwatch.

11. A process as recited in claim 10, further comprising allowing the user to scroll through bible verses.
